(19) United States
(12) Patent Application Publication
(10) Pub. No.: US 2018/0036760 A1
(43) Pub. Date: Feb. 8, 2018

(54) APPARATUS AND METHOD FOR THE DOSED DISPENSING OF A LIQUID

(71) Applicant: Henkel AG & CO, KGaA, DUESSELDORF (DE)

(72) Inventors: Christoph Schmid, Maisach OT (DE); Till Marxmueller, Munchen (DE)

(21) Appl. No.: 15/783,336

(22) Filed: Oct. 13, 2017

Related U.S. Application Data
(63) Continuation of application No. PCT/EP2016/055776, filed on Mar. 17, 2016.

(30) Foreign Application Priority Data
Apr. 15, 2015 (DE) 102015206760.2

(51) Int. Cl. B05C 11/10; G01F 23/14; G01F 13/00

(52) U.S. Cl. CPC B05C 11/101; G01F 13/00; G01F 23/14

(57) ABSTRACT

The invention relates to an apparatus for the dosed dispensing of a liquid, comprising a dispensing vessel (10) which has a dispensing opening (12) for the liquid and a compressed-air port (14), a compressed-air system (16) for the provision of compressed air, a connecting line (15) by way of which the compressed-air port (14) of the dispensing vessel (10) is connected to the compressed-air system (16); and a sensor device for determining the fill level of the liquid in the dispensing vessel (10). According to the invention, the sensor device is connected by way of the connecting line (15) to the dispensing vessel (10). The dispensing opening (12) is closable. The invention also relates to a method using the apparatus.

The invention relates to an apparatus and a method for the dosed dispensing of a liquid.

There is known from the prior art an apparatus by which a dosed dispensing of liquid from an air-tight dispensing vessel takes place. The dispensing vessel has a dispensing opening for the liquid and a compressed-air port so that the dispensing vessel can be pressurized. When a particular pressure is applied for a certain time, the liquid is pushed out of the dispensing vessel for said time. A compressed-air system is provided for the provision of the compressed air. The compressed-air port of the dispensing vessel is connected to the compressed-air system by way of a connecting line. The fill level of the liquid in the dispensing vessel can be measured by means of a sensor device. This ensures that a dispensing vessel in use can be replaced in good time by a new, full dispensing vessel.

If, for example, a PUR hot-melt adhesive in liquid form is to be applied by the apparatus to surfaces that are to be bonded, the PUR hot-melt adhesive in the dispensing vessel must be kept at a certain temperature, which limits the choice of possible sensors. The particular nature of the liquid can also rule out those sensors that must have direct contact with the liquid in order to detect the fill level.

Capacitive sensors, which operate on the basis of the change in capacitance of an individual capacitor or of an entire capacitor system, have the advantage that they need not come into contact with the liquid when determining the fill level. However, it should be noted that the chemical composition of the liquid for which the fill level is to be determined has an influence on the measurement results of the capacitive sensor. For different liquids, therefore, the measured values of the sensor may differ for the same fill levels, and therefore a liquid-specific calibration of the sensor is required. Use of the capacitive sensor is also limited if the dispensing vessel has a large wall thickness. However, in the case of dispensing vessels which are pressurized in order to dispense the liquid, the wall thickness cannot be reduced as desired due to strength requirements. In addition, when replacing an empty dispensing vessel with a new dispensing vessel, it may be complicated to reattach and realign the sensor on the vessel.

The problem addressed by the invention is therefore that of providing an apparatus for the dosed dispensing of a liquid, in particular for dispensing a liquid adhesive such as heated PUR hot-melt adhesive, by which a dosed dispensing of the liquid and the determination of the fill level of the liquid in the dispensing vessel are possible in a simple and reliable manner.

The problem addressed by the invention is solved by the combination of features according to claim 1. Exemplary embodiments of the apparatus according to the invention can be found in the claims dependent on claim 1.

According to claim 1, the sensor device is connected by way of the connecting line to the dispensing vessel. In addition, the dispensing opening is closable. The sensor device may comprise a pressure sensor which measures the pressure in the connecting line. As an alternative or in addition, the sensor device may comprise an air quantity sensor which measures the quantity of air flowing through or into the connecting line.

The apparatus according to the invention has the advantage that, when replacing the vessel, the sensor device is connected directly as a result of connecting the connecting line to the compressed-air port of the dispensing vessel. There is no need for separate attachment and alignment, on the dispensing vessel, of a sensor for determining the fill level. As will be explained in greater detail below, a pressure change can be brought about in the dispensing vessel in various ways via the compressed-air system. The magnitude of the pressure change that results for a particular volume change or for a particular additional quantity of air flowing into the dispensing vessel depends on the air volume within the dispensing vessel. The liquid volume, that is to say the volume taken up by the liquid in the dispensing vessel, can be calculated from the air volume. For this, the air volume is subtracted from the constant total volume.

If the pressure is increased in the dispensing vessel for the purpose of determining the fill level, it should be ensured that no liquid is dispensed from the dispensing vessel while doing so. For this reason, the dispensing opening must be closable. The dispensing opening may be assigned a shut-off valve, by which the dispensing opening can be opened and closed. The shut-off valve may be a switching valve, which is actuated via a signal line.

In one exemplary embodiment, computer means are provided which calculate the fill level in the dispensing vessel from the measurement result of the pressure sensor and/or of the air quantity sensor. For example, a volume change ΔV can be brought about in the dispensing vessel, which leads to a pressure increase in the dispensing vessel. The air volume in the dispensing vessel, and thus the fill level and/or the liquid volume, can then be calculated from the pressure increase as a function of the volume change ΔV.

The compressed-air system may comprise a pneumatic cylinder which is directly or indirectly connected to the connecting line. The cylinder having the cylinder volume, the dispensing vessel having the air volume, the connecting line, as well as further lines or line sections of the compressed-air system which connect the dispensing vessel and pneumatic cylinder, form a test system having a corresponding test volume. This test volume can be reduced by reducing the cylinder volume by moving a piston in the cylinder. The cylinder volume is thus reduced by the stroke volume. The pressure sensor measures the pressure increase in the test volume or the pressure prior to actuation of the piston and the pressure after actuation of the piston. By using the general ideal gas equation:

P·V=m·R_{S}·T=const. (1)

where P pressure,

V volume,

M quantity of air,

R_{S} specific gas constant, and

T temperature,

the air volume in the dispensing vessel can be determined. Knowing the total volume of the dispensing vessel, the liquid volume taken up by the liquid, which is a measure of the fill level, can be obtained from the air volume in the dispensing vessel. The pressure increase in the test system can in this case be measured at different points since the same pressure is quickly set throughout.

The compressed-air system may comprise a throttle valve which is connected to the connecting line. It is thus possible to introduce into the dispensing vessel an air flow that is limited in terms of its magnitude. An air quantity sensor measures the quantity of air in question. If the pressure increase thereby brought about in the test system is determined, it is thus once again possible to calculate the air volume in the dispensing vessel and thus the fill level of the liquid in the dispensing vessel. Particularly in the case of a dispensing vessel that is almost completely empty, which then has a large air volume, the difference between the quantity of air flowing into the dispensing vessel and the total quantity of air supplied to the test system is large whenever measured with the same pressure increase.

The pressure system may comprise a proportional valve which is connected (directly or indirectly) to the connecting line. In this case, there is no need for a separate throttle valve.

On the one hand, the proportional valve can be used to bring about the pressure change in the dispensing vessel that is necessary in order to determine the fill level. On the other hand, however, it can also provide the pressure for dispensing liquid from the dispensing vessel. However, the compressed-air system may also comprise a switching valve which serves only to provide the pressure for dispensing liquid. A further switching valve may be provided only for generating a pressure change for determining the fill level. For example, it could generate pressure for moving the piston in the cylinder so that the test volume is reduced by the stroke volume in the cylinder. Or it is used, preferably in conjunction with a throttle valve, to generate an air flow that is delivered into the dispensing vessel or into the test system, the latter being composed of the dispensing vessel, the connecting line and the relevant parts of the compressed-air system.

A further problem addressed by the invention, that of providing a simple method for the dosed dispensing of liquid and for determining the fill level, is solved by the combination of features according to claim 8. Exemplary embodiments can be found in the claims dependent on claim 8.

The method according to the invention uses the above-described apparatus for dispensing liquid, wherein the apparatus is operated in a dispensing mode in which the dispensing opening is open. In order to determine the fill level of liquid in the dispensing vessel, the apparatus is operated in a test mode in which the dispensing opening is closed. Both in the dispensing mode and in the test mode, the dispensing vessel is pressurized or the pressure is changed. In the dispensing mode, the pressure serves to push liquid out of the dispensing vessel. In the test mode, the pressure change leads to new state variables P₂, V₂ at an instant t₂, from which the air volume in the dispensing vessel can then be determined according to equation 1 in comparison to old state variables P₁, V₁ at an earlier instant t₁.

Preferably, the compressed-air system in the test mode brings about a pressure change in the dispensing vessel. The pressure change may be brought about by a particular volume change which, as described above, is achieved for example by moving the piston in the pneumatic cylinder. The pressure change and/or the pressure in the dispensing vessel is measured.

In one exemplary embodiment, a reference pressure change is determined for a reference fill level in the dispensing vessel. By way of example, the reference fill level may be the fill level of a completely empty dispensing vessel. Such a state can then be associated with corresponding pressure change which is then the reference pressure change. When using a full or half-full dispensing vessel, the pressure change then measured can be compared with the reference pressure change. If the measured pressure change is greater than the reference pressure change, preferably taking account of a safety margin of 0.1 to 0.3 bar or a safety factor of 2 to 5%, this permits the conclusion that the dispensing vessel is not yet (completely) empty. The apparatus can in this case continue to be operated.

However, if the measured pressure change corresponds to the reference pressure change, or if the measured pressure change is close to the reference pressure change, it must be assumed that the dispensing vessel is completely empty and must be replaced. By way of example, the apparatus may have display means which indicate an excessively low fill level. As an alternative or in addition, a stop signal may be generated in this case. Instead of the reference pressure change, an absolute reference pressure can also be used as the basis.

A predetermined value can be predefined for the pressure change or for a pressure in the dispensing vessel, the quantity of air required for the pressure change or for building up the pressure being measured. The larger the quantity of air, the greater the air volume in the dispensing vessel. Detecting the required quantity of air has the advantage that, for an almost empty dispensing vessel, relatively large values are measured for the required quantity of air. The measurement accuracy thus increases as the liquid volume or fill level decreases. This enables relatively precise information regarding the fill level for a completely or almost completely empty dispensing vessel. It is also possible to predefine a value for the quantity of air to be supplied and then to measure the resulting pressure change. However, this can lead to measurement inaccuracies since small or smaller pressure changes are to be expected for a completely empty dispensing vessel.

For a reference fill level, a reference quantity of air can be determined in the dispensing vessel in the context of a reference measurement, a measured quantity of air being compared with the reference quantity of air. Here, too, the reference fill level may be the fill level of an (almost) completely empty dispensing vessel (for example 1 to 3% of the total volume of the dispensing vessel. For such a fill level, the quantity of air for generating a particular pressure change in the dispensing vessel or a particular pressure therein is determined. When the quantity of air required to obtain the predetermined value for the pressure change or the pressure is then determined for a partially filled dispensing vessel, this average quantity of air can be compared with the reference quantity of air. As long as the measured quantity of air is less than the reference quantity of air, the fill level is greater than the fill level at the time of performing the reference measurement.

In one exemplary embodiment, the apparatus is operated alternately in the dispensing mode and then in the test mode. A dispensing interval or a block of two, three or more dispensing intervals is thus always followed by a test interval. If in each case a particular quantity of liquid is to be dispensed in a dispensing interval (setpoint value), the test interval following the dispensing interval is used to determine how large a quantity of liquid has actually been dispensed in the dispensing interval (actual value). To this end, the fill level in the dispensing vessel at the end of the dispensing interval is compared with the fill level in the dispensing vessel at the start of the dispensing interval. As the fill level at the start of a dispensing interval n, use can be made of the fill level at the end of a preceding dispensing interval n−1. By comparing the actual value with the setpoint value, quality control can be carried out for each individual dispensing interval. If, for example in the context of series production, a particular quantity of adhesive is applied to a component by the apparatus according to the invention in one dispensing interval, it is possible in the subsequent test mode to make a decision as to whether said component should be rejected on account of an excessively large difference between the setpoint value and the actual value. For a dispensing vessel that is being emptied, the comparison of setpoint value to actual value can also be used to track the pressure by which the adhesive is being pressed out of the dispensing vessel. For example, the pressure can be raised if the actual value is moving increasingly further away from the setpoint value as the dispensing vessel empties.

Regardless of the above-described comparison of setpoint value and actual value of a dispensing interval, different pressures can be applied to the dispensing vessel in the dispensing mode depending on the fill level. For example, as the fill level decreases, the pressure can be increased via a function that has been determined beforehand and then stored. To this end, the fill level can be determined at regular intervals in the test mode. By virtue of a higher pressure, it is possible to compensate for a certain temporal delay in the dispensing of liquid in response to the pressurization of the dispensing vessel. The greater the air volume in the dispensing vessel, the softer and less precise is the dispensing behavior of the apparatus. This effect can be compensated by increasing the pressure with which the liquid is pushed out of the dispensing vessel.

The invention will be explained in greater detail with reference to the exemplary embodiments shown in the drawing, in which:

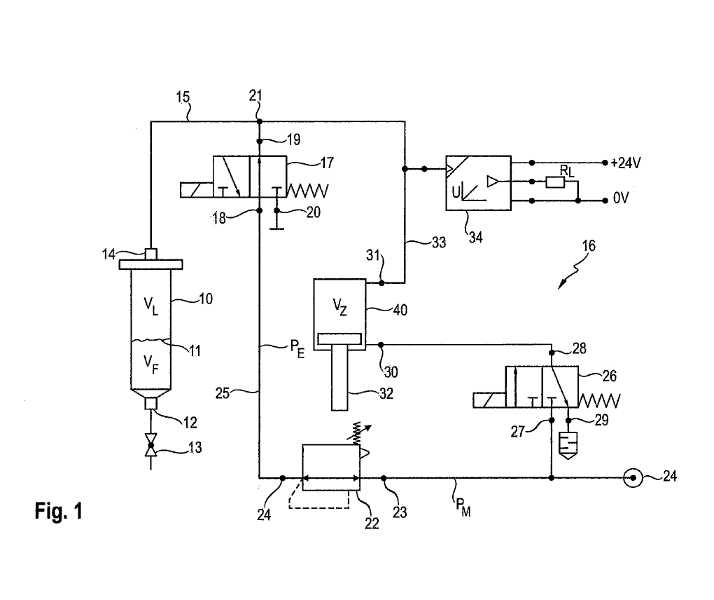

FIG. 1 shows a block diagram for a first exemplary embodiment of the apparatus according to the invention;

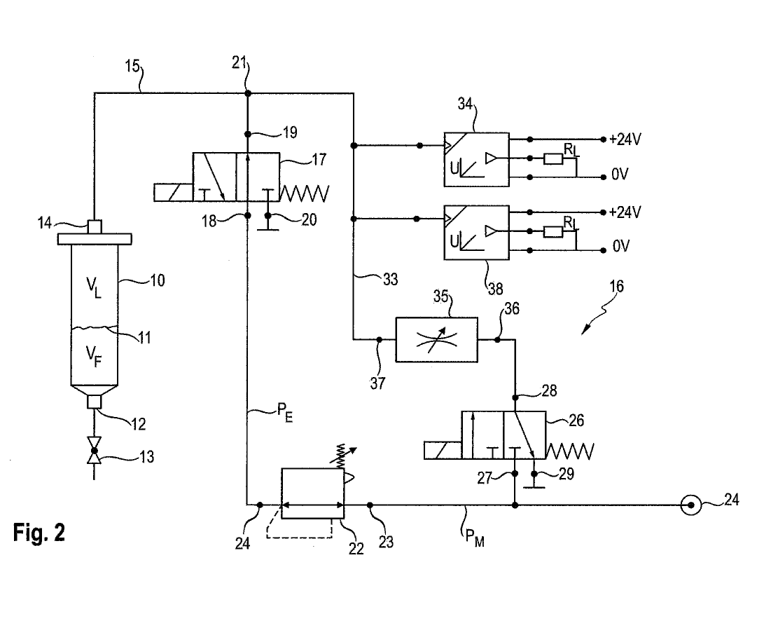

FIG. 2 shows a block diagram for a second exemplary embodiment, and

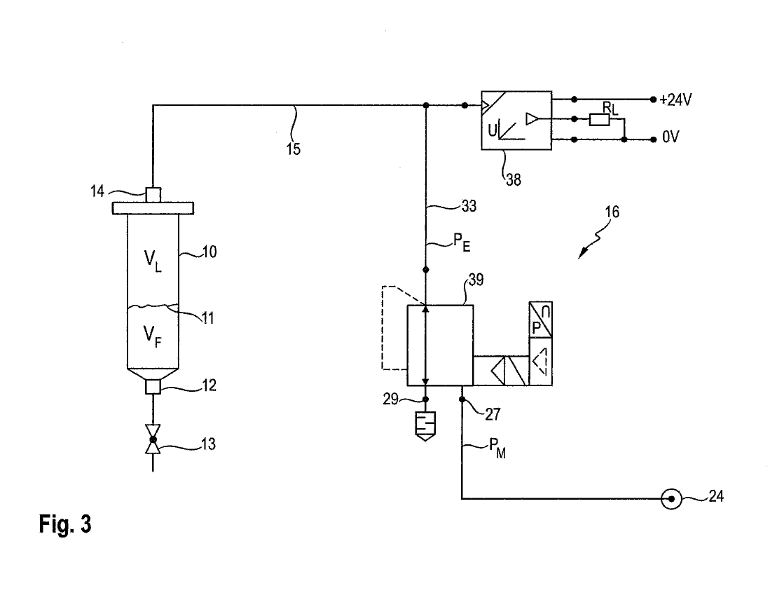

FIG. 3 shows a block diagram for a third exemplary embodiment.

FIG. 1 shows a simplified block diagram for a first exemplary embodiment of the invention. A dispensing vessel 10, which is air-tight and rigid, is partially filled with a liquid. A fill level line 11 indicates the fill level of the liquid within the dispensing vessel 10. Air is located above the fill level line 11, and the liquid is located below said line. An air-filled volume V_{L} (air volume) and a liquid-filled volume V_{F} (liquid volume) are thus obtained in the dispensing vessel 10 depending on the fill level (see fill level line 11). While the volumes V_{L} and V_{F} depend on the fill level in the dispensing vessel 10 and are therefore variable, the sum of the two volumes V_{L}, V_{F} is constant and corresponds to a total volume of the dispensing vessel V_{G}.

When the dispensing vessel 10 is in the use position shown in FIG. 1, a dispensing opening 12 for the liquid is provided at a lower end of the dispensing vessel. A shut-off valve 13 is assigned to the dispensing opening 12. The dispensing opening 12 can be opened and closed by the shut-off valve 13.

A compressed-air port 14 is provided at an end opposite the dispensing opening 12. Connected to said compressed-air port 14 is a connecting line 15 which connects the dispensing vessel 10 to a compressed-air system 16. In the exemplary embodiment shown here, the compressed-air port 14 and the dispensing opening 12 are arranged diametrically to one another, which is not absolutely necessary. It is sufficient if the dispensing opening 12 is positioned in such a way that the liquid is in front of this dispensing opening 12 and dispensing without air is possible. In the present case, gravity ensures this.

When the air-tight dispensing vessel 10 is pressurized by the compressed-air system 16 via the connecting line 15 and the compressed-air port 14, liquid is pressed out of the dispensing vessel 10 through the dispensing opening 12 and the open shut-off valve 13. By way of example, the vessel 10 may be a glue cartridge containing PUR hot-melt adhesive. Hot-melt adhesive can thus be applied by the apparatus to components or surfaces to be bonded. The dispensing vessel 10 must be kept at a temperature such that the hot-melt adhesive remains liquid. It may thus have heating means or connections for a heating medium for heating the liquid in the dispensing vessel.

The compressed-air system 16 has a first switching valve 17 which is configured as a 3/2-way valve. The switching valve 17 can be switched into a first switching position and into a second switching position. FIG. 1 shows the first switching position, which corresponds to a spring-loaded rest position of the first switching valve 17. This rest position occurs when no signal current is present at the first switching valve (“normally closed”). In the rest position, a first inlet 18 is connected to an outlet 19. In the second switching position, the first inlet 18 and the outlet 19 are isolated from one another. In this case, in the nomenclature of the block diagram, the outlet 19 is connected to a second inlet 20 of the first switching valve, the second inlet 20 being configured as a blind inlet. In fact, in the second switching position, the first switching valve is thus closed so that no air can escape through the outlet 19 via a node point 21.

A manually adjustable pressure regulator 22 is disposed upstream of the first inlet 18 of the first switching valve 17. A pressure P_{M}, which is provided by a pressure supply 24, is applied to an inlet 23 of the pressure regulator 22. From the main pressure P_{M}, the pressure regulator 22 generates an adjustable pressure P_{E}. Via a (pressure) line 25, which connects the outlet 24 of the pressure regulator 22 to the first inlet 18 of the first switching valve 17, this pressure P_{E} can be switched to the dispensing vessel 10 by way of the first switching valve 17. When the shut-off valve 13 is open, liquid is thus pushed out of the dispensing vessel 10 through the dispensing opening 12. If the dispensing of liquid is to be interrupted, the shut-off valve 13 is closed.

The compressed-air system 16 has a second switching valve 26. This switching valve 26 is also configured as a 3/2-way valve. A first inlet 27 of the second switching valve 26 is connected to the pressure supply 24. An outlet 28 of the second switching valve 26 can be depressurized via a second inlet 29 when the second switching valve 26 is in the switching position shown in FIG. 1 (“normally open”). This is a first switching position or a spring-loaded rest position. When a signal current is present, the second switching valve 26 switches into a second switching position, in which the first inlet 27 is connected to the outlet 28. The main pressure P_{M} is thus applied to the outlet 28 of the second switching valve 26.

Also provided is a pneumatic cylinder 40 which is disposed downstream of the second switching valve 26. The cylinder 40 has an inlet 30 and an outlet 31. If the main pressure P_{M} is switched to the inlet 30 of the cylinder 40 by way of the second switching valve 26, a piston 32 of the cylinder 40 pushes the air located in the cylinder 40 into the line 32 via the outlet 31. If it is assumed that the cylinder volume V_{Z} corresponds to the volume that can be pushed out of the cylinder 40 by the piston, the remaining cylinder volume is zero in an upper dead center of the piston 32.

Connected to the pressure line 33 is a pressure sensor 34, by which the pressure in the pressure line 33 and thus also in the dispensing vessel 10 can be measured.

The apparatus can be operated in a dispensing mode and in a test mode. In the dispensing mode, the shut-off valve 13 is open. The switching valves 17, 26 are in the switching positions shown in FIG. 1. Liquid is pushed out of the dispensing vessel 10 via the dispensing opening 12 by the pressure P_{E} generated by the pressure regulator 22. By switching the first switching valve 17, the dispensing can be timed. For example, if the first switching valve 17 is in the open first switching position for 10 seconds, then liquid will be dispensed from the dispensing vessel 10 for these 10 seconds.

In the test mode, the first switching valve 17 is in the second switching position, in which the outlet 19 is closed. The shut-off valve is closed. At an instant t₁, at which the piston 32 is in the position shown in FIG. 1, a pressure P₁ is determined by the pressure sensor 34. At this instant, a test volume V₁ of a test system is composed of the air volume V_{L} in the dispensing vessel 10 and the cylinder volume V_{Z} in the cylinder 40. The volumes V₁₅, V₃₃ of the lines 15, 33 or of all line sections located between the cylinder 40 and the dispensing vessel 10 must also be taken into account. The second switching valve 26 is then brought into the second switching position so that the piston 32 pushes the volume V_{Z} out of the cylinder 40. At the end of the movement of the piston 32 at an instant t₂, a new pressure P₂ thus exists in the dispensing vessel, this new pressure being greater than the pressure P₁ since the test volume of the test system is now smaller. The volume V₂ at instant t₂ corresponds to the volume V₁ minus V_{Z}. According to the general gas equation (see equation (1)):

(V_{L}+V_{Z}+V₃₃+V₁₅)·P₁=(V_{L}+V₃₃+V₁₅)·P₂ (2)

where V_{L} air volume in the dispensing vessel;

V_{Z} cylinder volume;

V₃₃ volume of the pressure line 33;

V₁₅ volume of the connecting line 15;

P₁ pressure at the instant t₁;

P₂ pressure at the instant t₂.

From equation 2, the air volume V_{L} can be calculated by transformation. Knowing the total volume V_{G} of the dispensing vessel 10, the quantity V_{F} or the fill level to be determined can be obtained directly from the air volume V_{L}.

FIG. 2 shows a block diagram for a further exemplary embodiment. Components or features which are similar or identical to components or features of FIG. 1 are provided with the same reference signs. This also applies to the exemplary embodiment shown in FIG. 3.

The basic structure of the apparatus shown in FIG. 2 corresponds to the structure of the apparatus 1. Reference is therefore made to what has been stated in respect of FIG. 1. Instead of the cylinder 40 shown in FIG. 1, a throttle valve 35 having an inlet 36 and an outlet 37 is disposed downstream of the second switching valve 26. In the first switching position of the second switching valve 26, as is also the case in the exemplary embodiment of FIG. 1, the outlet 28 is connected to the second inlet 29. However, the outlet 28 is not depressurized as a result but rather is closed in an airtight manner.

Provided in addition to the pressure sensor 34 is an air quantity sensor 38 which measures the quantity of air flowing through the compressed-air line 33. The line 33 connects the outlet 37 of the throttle valve 35 to the connecting line 15.

The structure differing from the first exemplary embodiment has essentially no effect on the operation of the apparatus of FIG. 2 in the dispensing mode. In other words, the second exemplary embodiment does not differ from the first exemplary embodiment with regard to use in the dispensing mode. In the test mode, on the other hand, the test system is reduced by a predetermined volume V_{Z}, but a particular quantity of air, which is detected by the air quantity sensor 38, is supplied to the test system. The additional quantity of air leads to a particular pressure increase. Again, the state variables are determined before (instant t₁) and after (instant t₂). The less the dispensing vessel 10 is filled with the liquid, the greater the quantity of air that must be supplied to the test system in order to achieve a particular pressure increase. The quantity of air required for this is thus a measure for the air volume V_{L} in the dispensing vessel and the fill level in the dispensing vessel. Using the following equation, which is once again based on the general gas equation, the fill level can be determined as a function of the measured quantity of air:

m_{D}·R_{S}·T=(V_{L}+V₁₅+V₃₃)·(P₂−P₁) (3)

where m_{D} quantity of air supplied in time interval between t₁ and t₂;

T temperature of the supplied quantity of air;

R_{S} specific gas constant;

V₃₃ volume of the pressure line 33;

V₁₅ volume of the connecting line 15;

P₁ pressure at the instant t₁;

P₂ pressure at the instant t₂.

Compared to the exemplary embodiment of FIG. 1, the exemplary embodiment of FIG. 2 has the advantage that, in order to achieve a predetermined pressure increase or a pressure P₂, the quantity of air required for this is comparatively large in the case of an almost empty or completely empty dispensing vessel 10. The measurement accuracy thus increases as the fill level decreases. This is advantageous when the accurate and reliable determination of the fill level of (almost) completely empty dispensing vessels is of particular importance.

In the exemplary embodiment of FIG. 3, the functions which are fulfilled by the switching valves 17, 26 and the throttle valve 35 in the exemplary embodiment of FIG. 2 are taken over by a proportional valve 39. When the apparatus is in the dispensing mode, that is to say the shut-off valve 13 is open, the proportional valve 39 provides in the dispensing vessel 10 the pressure that is necessary for dispensing the liquid. However, the proportional valve 39 can also be used in the test mode, in which the shut-off valve 13 is closed. In this case, it supplies an additional quantity of air, which is measured by the air quantity sensor 38, to the pneumatic test system (here: line 33, connecting line 15 and dispensing vessel 10 having the test volume V₃₃+V₁₅+V_{L}. Since with the proportional valve 39 there is the possibility of precisely defining a target pressure value, there is no need for a separate pressure sensor 34. As also in the exemplary embodiment of FIG. 2, the quantity of air required for a pressure increase is measured in order to determine the fill level.

The test volume of the test system (air-filled portion of the dispensing vessel 10, connecting line 15 and line 33) can be 1 to 2000 ml, preferably 60 to 350 ml. The cylinder volume V_{Z} can assume values of 1 to 2000 ml. A preferred range for V_{Z} extends from 12 to 70 ml. The pressures P1 and P2 can be 0.1 to 12, preferably 0.2 to 5 bar. The pressure change P2−P1 brought about by reducing the test volume by the cylinder volume V_{Z} or by the supplied quantity of air can assume values of 0.02 to 5 bar. The supplied quantity of air can be between 80 and 0.25 mg, preferably between 40 and 0.28 mg. The temperature in the dispensing vessel can be 10 to 200, preferably 20 to 180 or 100 to 170° C.

### LIST OF REFERENCE SIGNS

10 dispensing vessel
11 fill level line
12 dispensing opening
13 shut-off valve
14 compressed-air port
15 connecting line
16 compressed-air system
17 first switching valve
18 first inlet
19 outlet
20 second inlet
21 node point
22 pressure regulator
23 inlet
24 outlet
25 (pressure) line
26 second switching valve
27 first inlet
28 outlet
29 second inlet
30 inlet
31 outlet
32 piston
33 (pressure) line
34 pressure sensor
35 throttle valve
36 inlet
37 outlet
38 air quantity sensor
39 proportional valve
40 cylinder

What is claimed is:

1. An apparatus for the dosed dispensing of a liquid, comprising
a dispensing vessel (10) which has a dispensing opening (12) for the liquid and a compressed-air port (14);
a compressed-air system (16) for the provision of compressed air;
a connecting line (15) by way of which the compressed-air port (14) of the dispensing vessel (10) is connected to the compressed-air system (16); and
a sensor device for determining the fill level of the liquid in the dispensing vessel (10),
characterized in that the sensor device is connected by way of the connecting line (15) to the dispensing vessel (10), and in that the dispensing opening (12) is closable.

2. The apparatus according to claim 1, characterized in that the sensor device comprises a pressure sensor (34) which measures the pressure in the connecting line (15) and/or in the dispensing vessel (10).

3. The apparatus according to claim 1, characterized in that the sensor device comprises an air quantity sensor (38) which measures the quantity of air flowing through or into the connecting line (15).

4. The apparatus according to claim 2, characterized in that computer means are provided which calculate the fill level in the dispensing vessel (10) from the measurement result of the pressure sensor (34) and/or of the air quantity sensor (38).

5. The apparatus according to claim 1, characterized in that the compressed-air system (16) comprises a pneumatic cylinder (29) which is connected to the connecting line (15).

6. The apparatus according to claim 1, characterized in that the compressed-air system (16) comprises a throttle valve (35) which is connected to the connecting line.

7. The apparatus according to claim 1, characterized in that the pressure system (16) comprises a proportional valve (39) which is connected to the connecting line (15).

8. A method for the dosed dispensing of liquid using an apparatus according to claim 1, wherein, for dispensing liquid, the apparatus is operated in a dispensing mode in which the dispensing opening (12) is open, and wherein, for determining the fill level of liquid in the dispensing vessel (10), the apparatus is operated in a test mode in which the dispensing opening (12) is closed.

9. The method according to claim 8, characterized in that, in the test mode, a pressure change in the dispensing vessel (10) is brought about by the pressure system.

10. The method according to claim 9, characterized in that the pressure change is due to a predetermined change in volume, and the pressure change and/or the pressure in the dispensing vessel (10) is measured.

11. The method according to claim 10, characterized in that a reference pressure change is determined for a reference fill level in the dispensing vessel (10), a measured pressure change being compared with the reference pressure change.

12. The method according to claim 9, characterized in that a predetermined value is predefined for the pressure change or for a pressure in the dispensing vessel (10) and the quantity of air required for the pressure change or for building up the pressure is measured.

13. The method according to claim 12, characterized in that a reference quantity of air is determined for a reference fill level in the dispensing vessel (10), a measured quantity of air being compared with the reference quantity of air.

14. The method according to claim 8, characterized in that the apparatus is operated for a given time in the dispensing mode and then in the test mode in order to determine, via a change in fill level, the quantity dispensed in the given time.

15. The apparatus according to claim 8, characterized in that the dispensing vessel (10) is subjected to different pressures in the dispensing mode depending on the fill level.
